(19) United States
(12) Patent Application Publication
(10) Pub. No.: US 2006/0027949 A1
(43) Pub. Date: Feb. 9, 2006

(54) Device of microstructure imprint for pattern transfer and method of the same

(75) Inventors: Wei-Han Wang, Taipei (TW); Chia-Hung Lin, Hsinchu (TW); Yu-Lun Ho, Chiayi (TW); Jen-Hua Wu, Changhua (TW)

Correspondence Address: BRUCE H. TROXELL, SUITE 1404, 5205 LEESBURG PIKE, FALLS CHURCH, VA, 22041, US

(73) Assignee: Industrial Technology Research Institute

(21) Appl. No.: 10/938,528

(22) Filed: Sep. 13, 2004

(30) Foreign Application Priority Data
Aug. 6, 2004 (TW) 93116364

(51) Int. Cl. B29C 51/08

(52) U.S. Cl. 264/322; 264/446; 425/174.8 R

(57) ABSTRACT

The microstructure imprint device of the invention comprises: a supporting plate, a substrate, a moldable layer, a mold, and a microwave source, wherein the microwave discharged from the microwave source is being provided to the substrate, the moldable layer and the mold for heating up the moldable laye so as to soften the moldable layer, and the substrate having a layer of moldable layer arranged thereon is being placed on the supporting plate, and the mold is disposed at a position corresponding to the substrate and the supporting plate such that the mold can be pressed on the moldable layer for pattern transferring. The device the present invention is capable of enhancing the thermal state of a moldable layer in a short time by means of electromagnetic wave, such that the moldable layer can be heated in a short time and further the moldable layer can be softened.

### FIELD OF THE INVENTION

The present invention relates to a device of microstructure imprint for pattern transfer and method of the same, and more particularly, of a device and method of microstructure imprint capable of changing the thermal state of a moldable layer and softening it in a short time.

### BACKGROUND OF THE INVENTION

The current process for fabricating semiconductor devices typically involves several different steps, one of which is a step of lithography, and preferably an optical lithography step. However, the resolution of the optical lithography is limited by the nature of diffraction hence it is hard to perform a sub-100 nm microstructure. Recently, the imprint lithography technology is recognized to replace the conventional lithography for semiconductor device since the nanoimprint lithography (NIL) process using compressive molding of thermal-plastic polymers is a low-cost mass-manufacturing technology.

There are several major steps in a microstructure imprint process, including heating, pressing, cooling, and demolding, wherein the heating and cooling steps occupy about 70% cycle time of a typical imprint process. The throughput and manufacturing speed of the process can be significantly increased if the heating and cooling efficiencies are increased.

Generally, the total mass of the heated objects is an important factor affecting the heating efficiency as well as providing the high heating power. The electro-thermal heating device is most commonly seen in a conventional microstructure imprint process. The electro-thermal heating device, such as the electro-thermal tube seen in FIG. 1 and the electro-thermal plate seen in FIG. 2, etc., is able to provide a stable heat source, but it requires an electro-thermal apparatus to be in contact with the thermal material thereof. In this regard, a conceivable amount of the heated objects is generated in the electro-thermal heating process, which is vulnerable to thermal deformation. In addition, although providing a high heating power for the heating objects can greatly increase the heating rate, the temperature distribution of the heated objects could not keep homogeneous, and even a thermal pattern effect could occur.

The PCT Pat. No. WO 01/63361 discloses a device for homogeneous heating of an object. The device comprises an adiabatic plate, a heating layer, an electrical insulating plate, and a supporting plate, wherein the heating layer is connected to a power source. The heating layer is a thin layer of graphite with high thermal conductivity and is able to generate thermal energy while it is provided with electric power. The adiabatic plate arranged under the heating layer is exposed to high temperatures and aims at retroreflecting thermal energy emitted from the heating layer and, thus, conducting practically all emitted thermal energy towards the supporting surface. In this regard, the device of WO 01/63361 is capable of homogenously heating up a substrate and a moldable layer placed thereon. According to an embodiment of the PCT Pat. No. WO 01/63361, the heating layer can be heated by radiation of lamp or by means of ultrasonic source, whose wavelength is adjusted so as to be absorbed in the heating layer. The heating effect of the device of the PCT Pat. No. WO 01/63361 is better than that of a general electro-thermal tube or electro-thermal plate since it applies a thin heating layer of small mass, which is made of a material having a positive temperature coefficient and sufficiently high electric resistivity. However, the prior art heats up an object by placing the object directly on the supporting surface of a heating layer that can still be improved.

To sum up, the conventional microstructure imprint device and method of prior arts have the following shortcomings:
1. All the conventional methods adopt a means of heat conduction to heat up the moldable layer indirectly through a heated intermedium, that the indirect heating means can cause thermal energy to be lost during the heat conduction, and the indirect heating means also has poor heating efficiency since the mass of thermal material needed in the indirect heating means is comparably grand.
2. The conventional methods adopt an electro-thermal means for heating up an intermedium, that the thermal pattern effect could occur if an improper intermedium is used and enable a non-homogeneous temperature distribution, such that the precision of pattern transfer is affected, and further the dimension of the pattern to be transferred is limited by the poor precision.

3. The conventional methods adopting a means of heat conduction require a comparative large amount of thermal material that it requires a longer time to be heated up or cooled down, such that the commercial competitiveness is affected since the time spent in a process cycle is comparatively long.

### SUMMARY OF THE INVENTION

In view of the above disclosed shortcomings, it is the primary object of the invention to provide a device of microstructure imprint for pattern transfer and method of the same, which is capable of enhancing the thermal state of a moldable layer in a short time by means of electromagnetic wave, such that the moldable layer can be heated in a short time without using the heat conduction means of prior art, and therefore, the device of the present invention can reduce the amount of heat lost in the heating step and improve the heating rate of the moldable layer.

Another object of the invention is to provide a device of microstructure imprint for pattern transfer and method of the same, which requires only a comparable small mass of thermal material so that it has a preferred heating efficiency.

### BRIEF DESCRIPTION OF THE DRAWINGS

FIG. 1 is a diagram showing an electro-thermal tube of a conventional heating device for microstructure imprint.

FIG. 2 is a diagram showing an electro-thermal plate of a conventional heating device for microstructure imprint.

FIG. 3 is a schematic diagram showing a microstructure imprint device according to a first embodiment of the present invention.

FIG. 4 is a schematic diagram showing a microstructure imprint device according to a second embodiment of the present invention.

FIG. 5 is another schematic diagram showing a microstructure imprint device according to a second embodiment of the present invention.

FIG. 6 is a schematic diagram showing a microstructure imprint device according to a third embodiment of the present invention.

FIG. 7 is a schematic diagram showing a microstructure imprint device according to a fourth embodiment of the present invention.

FIG. 8 is a flow chart of a microstructure imprint method according to the present invention.

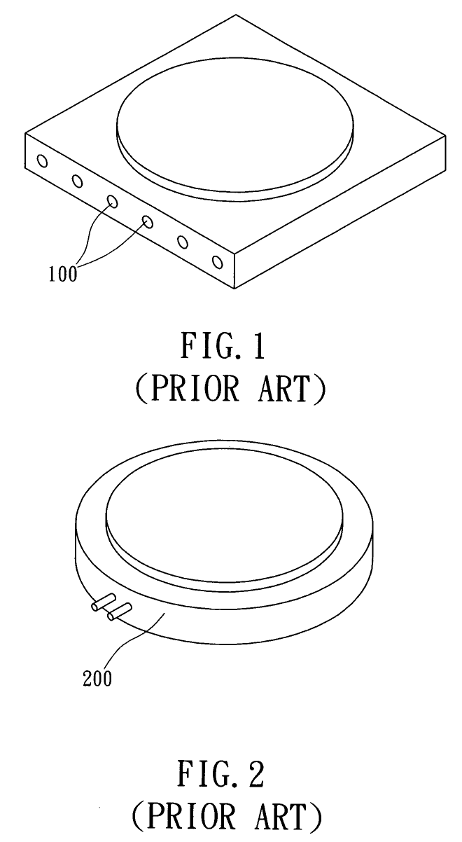

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

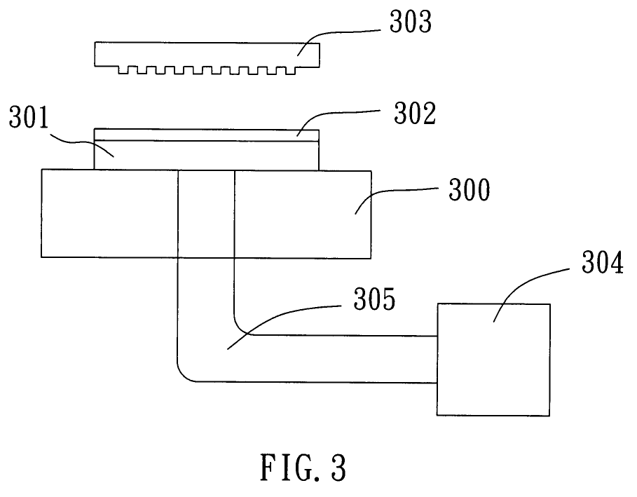

Please refer to FIG. 3, which is a schematic diagram showing a microstructure imprint device according to a first embodiment of the present invention. The microstructure imprint device of the first embodiment of the invention comprises: a supporting plate 300, a substrate 301, a moldable layer 302, a mold 303, a microwave source 304 and a waveguide device 305, wherein the waveguide device 305 is employed as the intermedium for transmitting microwave discharged from the microwave source 304, and the substrate 301 having a layer of moldable layer 302 arranged thereon is being placed on the supporting plate 300, and the mold 302 with sub-100 nm structures is disposed at a position corresponding to the substrate 301 and the supporting plate 300. Since the substrate 301, the moldable layer 302 and the mold 303 all are able to absorb at least a portion of the microwave energy at the same time, the microwave energy can be consumed and converted into thermal energy by the substrate 301, the moldable layer 302 and the mold 303 for enabling the moldable layer 302 to be softened. As the above description, the present invention can heat up the moldable layer 302 is a short time since it does not require either to apply the thermal conduction effect, or to heat up a mass of thermal material.

Microwave is a volume heating method for generating thermal energy which is much more efficiency than the conventional heating method applying thermal conduction. The power consumption of microwave is proportional to the mass of heated object and the heating time. In a microstructure imprint process, the substrate 301, the moldable layer 302 and the mold are relatively thin that they all have a comparatively small mass, therefore, it is not necessary to have a microwave source 304 of large power in the device of FIG. 3.

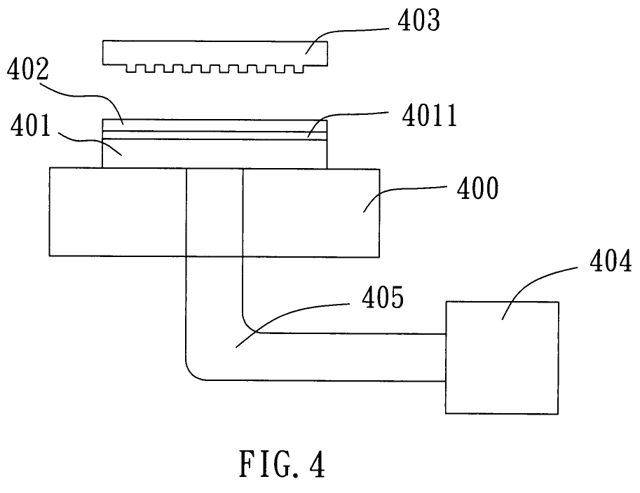

In the first embodiment of the invention, at least one object selected from the group consisting of the substrate 301, the moldable layer 302 and the mold 303 is made of a material capable of absorbing energy of electromagnetic wave. However, in operational, if no material capable of absorbing energy of electromagnetic wave can be used because of the limitation of manufacturing process or product requirement, the heating efficiency of the moldable layer can be affected. In this regard, the present invention provides another device as seen in a second embodiment of FIG. 4.

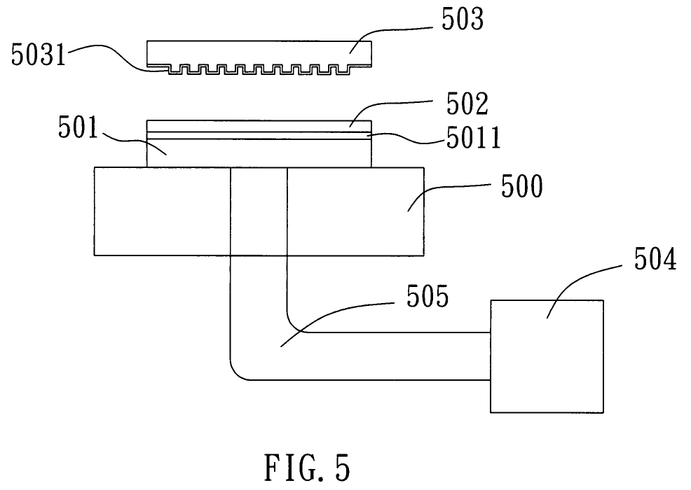

Please refer to FIG. 4, which is a schematic diagram showing a microstructure imprint device according to a second embodiment of the present invention. The microstructure imprint device of the second embodiment of the invention comprises: a supporting plate 400, a substrate 401, a microwave intermedium layer 4011, a moldable layer 402, a mold 403, a microwave source 404 and a waveguide device 405. The configuration and functions of the supporting plate 400, the substrate 401, the moldable layer 402, the mold 403, a microwave source 404, and the waveguide device 405 are similar to those of FIG. 3 that are not described further hereinafter. Nevertheless, the microwave intermedium layer 4011 is the main unit used for converting microwave energy into thermal energy. The microwave intermedium layer 4011 can be disposed between the substrate 401 and the moldable layer 402 as seen in FIG. 4. Moreover, as seen in FIG. 5, the microwave intermedium 5011 can be integrally formed inside the moldable layer 502 that is placed in the vicinity of the mold 503.

In the second embodiment on the invention, the microwave intermedium layer 4011 and 5011 can absorb at least a portion of microwave energy for converting the same into thermal energy, and further transmit the converted thermal energy to the moldable layer 402 for enabling the moldable layer 402 to be softened.

The microwave source seen in both the first embodiment and the second embodiment of the invention is a kind of electromagnetic wave source. Another kind of electromagnetic wave source is shown in the third embodiment of the invention.

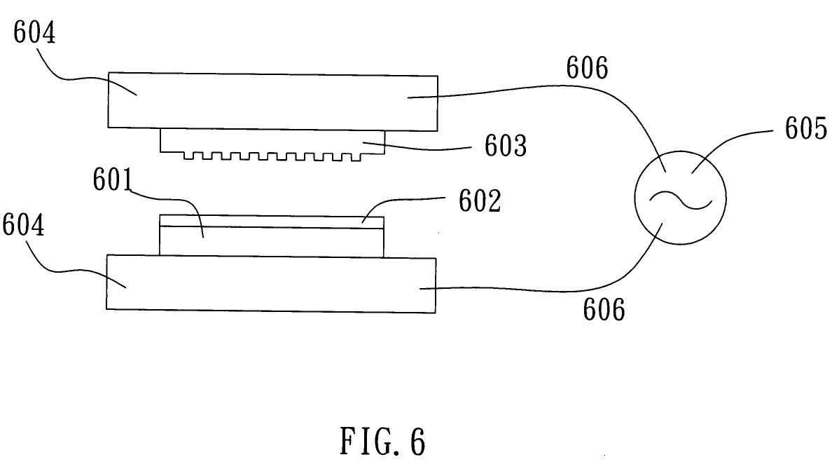

Please refer to FIG. 6, which is a schematic diagram showing a microstructure imprint device according to a third embodiment of the present invention. The microstructure imprint device of the third embodiment of the invention comprises: a substrate 601, a moldable layer 602, a mold 603, a set of electrodes 604, and a high-frequency wave source 605. The configuration and functions of the substrate 601, the moldable layer 602, and the mold 603 are similar to those of FIG. 3 that are not described further hereinafter. Nevertheless, the set of electrodes 604 is employed as the source producing electromagnetic field that are placed respectively at the side of the substrate 601 and the mold 603 as seen in FIG. 6.

In the third embodiment of the invention, the high-frequency wave source 605 is employed as the microwave source of the invention. The set of electrodes 604 is employed as the source producing electromagnetic field that are placed respectively at the side of the substrate 601 and the mold 603 as seen in FIG. 6. The power supply 6031 provides power to the electrodes 604 via the cable 606 such that an electromagnetic field can be produced between the two electrodes 604. In the third embodiment of the invention, at least one object selected from the group consisting of the substrate 601, the moldable layer 602 and the mold 603 is made of a material capable of absorbing a portion of energy of electromagnetic field and converting the same into thermal energy, such that the moldable layer 602 is heated and softened.

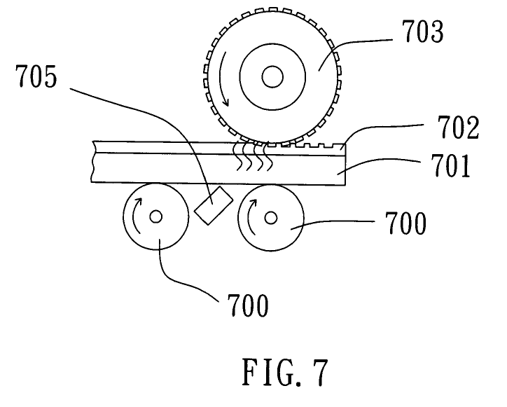

Please refer to FIG. 7, which is a schematic diagram showing a microstructure imprint device according to a fourth embodiment of the present invention. The microstructure imprint device of the fourth embodiment of the invention comprises: a conveyer 700, a substrate 701, a moldable layer 702, a roller mold 703, and a microwave source 705, wherein the substrate 701 having the moldable layer 703 forming thereon is being placed on the conveyer 700, and the roller mold 703 is a mold of continuous nano-pattern being arranged at a position corresponding to the conveyer 700. The substrate 701 having the moldable layer 703 forming thereon is disposed between the roller mold 703 and the conveyer 700 such the nano-pattern of the roller mold 703 is imprinted on the moldable layer 703 while the roller mold 703 is rotating with respect to the moving of the conveyer 700. The fourth embodiment of the invention is suitable for mass production. In the fourth embodiment of the invention, at least one object selected from the group consisting of the substrate 701, the moldable layer 702 and the roller mold 703 is made of a material capable of absorbing a portion of microwave energy and converting the same into thermal energy, such that the moldable layer 702 is heated and softened.

The pattern transferring operations of the first, the second and the third embodiments are a compression method achieved by a pressing movement. However, the pattern transferring operations of the fourth embodiment is a compression method achieved by a rolling and pressing motion.

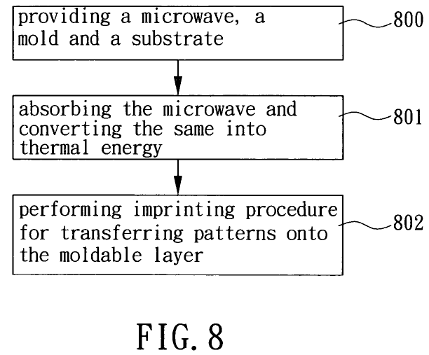

Please refer to FIG. 8, which is a flow chart of a microstructure imprint method according to the present invention. The microstructure imprint method comprises the steps of:
Step 800: providing a microwave, a mold and a substrate, wherein the substrate has a moldable layer formed thereon, and at least one object selected from the group consisting of the substrate, the moldable layer and the mold is made of a material capable of absorbing the microwave.
Step 801: absorbing the microwave and converting the same into thermal energy, and during the process, no matter whether a microwave or a high-frequency wave is employed as the electromagnetic wave source, at least one object selected from the group consisting of the substrate, the moldable layer and the mold is made of a material capable of absorbing the electromagnetic wave and directly converting the same into thermal energy, such that the method of the present invention can heat up the moldable layer is a short time since it does not require either to apply the thermal conduction effect, or to heat up a mass of thermal material.
Step 802: performing microstructure imprint procedure for transferring patterns onto the moldable layer. Since the thermal energy converted from the electromagnetic wave can heat up the moldable layer in a short time, and the stricture of the device of the invention also make possible for the heat to be dissipated in a short time, the cycle period of the microstructure imprint process can be shortened effectively.

To sum up, the invention to provide a device of microstructure imprint for pattern transfer and method of the same, which is capable of enhancing the thermal state of a moldable layer in a short time by means of electromagnetic wave, such that the moldable layer can be heated in a short time and further the moldable layer can be softened. The invention may be embodied in other specific forms without departing from the spirit or essential characteristics thereof. The present embodiment is therefore to be considered in all respects as illustrative and not restrictive, the scope of the invention being indicated by the appended claims rather by the foregoing description and all changes which come within the meaning and range of equivalency of the claims are therefore intended to be embraced therein.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A microstructure imprint device, comprising:
a substrate;
a moldable layer;
a mold; and
an electromagnetic wave source, providing the energy to soften the moldable layer;
wherein the mold is disposed at a position corresponding to the substrate for enabling the mold to be pressed on the moldable layer for performing a microstructure imprint process, and at least one object selected from the group consisting of the substrate, the moldable layer and the mold contains a material capable of absorbing energy of the electromagnetic wave.

2. The device of claim 1, wherein the said imprint process for pressing the mold toward the moldable layer is a translational pressing motion.

3. The device of claim 1, wherein the said imprint process for pressing the mold toward the moldable layer is a rotational pressing motion.

4. The device of claim 1, wherein the mold has a plurality of sub-100 μm patterns disposed thereon.

5. The device of claim 1, wherein the material capable of absorbing energy of electromagnetic wave is a mixture of an electromagnetic wave absorbent and a substance selected from the group consisting of polymer, metal, semiconductor, and ceramics.

6. The device of claim 1, wherein the frequency of the electromagnetic wave is in the range between 300 KHz and 300 GHz.

7. A microstructure imprint device, comprising:
a substrate;
a moldable layer;
a mold;
an electromagnetic wave source, providing the energy to soften the moldable layer; and
an electromagnetic wave intermedium layer, disposed between the substrate and the mold, capable of absorbing at least a portion of the electromagnetic energy discharged from the electromagnetic wave source and converting the same into thermal energy;
wherein the mold is disposed at a position corresponding to the substrate for enabling the mold to be pressed toward the moldable layer for performing the said imprint process.

8. The device of claim 7, wherein the said imprint process for pressing the mold toward the moldable layer is a translational pressing motion.

9. The device of claim 7, wherein the said imprint process for pressing the mold toward the moldable layer is a rotational pressing motion.

10. The device of claim 7, wherein the mold has a plurality of sub-100 μm patterns disposed thereon.

11. The device of claim 7, wherein the moldable layer is made up of a mixture of an electromagnetic wave absorbent and a substance selected from the group consisting of polymer, metal, semiconductor, and ceramics.

12. The device of claim 7, wherein the electromagnetic wave intermedium layer is composed of at least one layer of intermedium.

13. The device of claim 7, wherein the material forming the electromagnetic wave intermedium layer is a mixture of an electromagnetic wave absorbent and a substance selected from the group consisting of polymer, metal, semiconductor, and ceramics.

14. The device of claim 7, wherein the frequency of the electromagnetic wave is in the range between 300 KHz and 300 GHz.

15. A microimprint method, comprising the steps of:
providing an electromagnetic wave source, a mold and a substrate, wherein the substrate has a moldable layer thereon, and at least one object selected from the group consisting of the substrate, the moldable layer and the mold is made of a material capable of absorbing at least a portion of the electromagnetic energy and converting the same into thermal energy to soften the moldable layer;
performing the said imprint process for transferring patterns onto the moldable layer by pressing the mold toward the moldable layer.

16. The method of claim 15, wherein the said imprint process for pressing the mold toward the moldable layer is a translational pressing motion.

17. The method of claim 15, wherein the said imprint process for pressing the mold toward the moldable layer is a rotational pressing motion.

18. The method of claim 15, wherein the mold has a plurality of sub-100 μm patterns disposed thereon.

19. The method of claim 15, wherein the moldable layer is made up of a mixture of an electromagnetic wave absorbent and a substance selected from the group consisting of polymer, metal, semiconductor, and ceramics.

20. The method of claim 15, wherein the frequency of the electromagnetic wave is in the range between 300 KHz and 300 GHz.

21. A microimprint method, comprising the steps of:
providing an electromagnetic wave, a mold, an electromagnetic wave intermedium layer and a substrate, wherein the substrate has a moldable layer thereon, and the electromagnetic wave intermedium layer is capable of absorbing at least a portion of the electromagnetic energy and converting the same into thermal energy to soften the moldable layer;
performing a microimprint process for transferring patterns onto the moldable layer by pressing the mold toward the moldable layer.

22. The method of claim 21, wherein the said imprint process for pressing the mold toward the moldable layer is a translational pressing motion.

23. The method of claim 21, wherein the said imprint process for pressing the mold toward the moldable layer is a rotational pressing motion.

24. The method of claim 21, wherein the mold has a plurality of sub-100 μm patterns disposed thereon.

25. The method of claim 21, wherein the moldable layer is made up of a mixture of an electromagnetic wave absorbent and a substance selected from the group consisting of polymer, metal, semiconductor, and ceramics.

26. The method of claim 21, wherein the frequency of the electromagnetic wave is in the range between 300 KHz and 300 GHz.
